(19) United States
(12) Patent Application Publication
(10) Pub. No.: US 2024/0290102 A1
(43) Pub. Date: Aug. 29, 2024

(54) INFORMATION PROCESSING METHOD, INFORMATION PROCESSING APPARATUS, AND NON-TRANSITORY COMPUTER READABLE RECORDING MEDIUM

(71) Applicant: Panasonic Intellectual Property Corporation of America, Torrance, CA (US)

(72) Inventors: Hiroko IZUMI, Kanagawa (JP); Shigehiro IIDA, Tokyo (JP); Mitsuko SHUTO, Osaka (JP); Hiroki TAKEUCHI, Osaka (JP)

(73) Assignee: Panasonic Intellectual Property Corporation of America, Torrance, CA (US)

(21) Appl. No.: 18/656,050

(22) Filed: May 6, 2024

Related U.S. Application Data
(63) Continuation of application No. PCT/JP2022/023518, filed on Jun. 10, 2022.

(30) Foreign Application Priority Data
Nov. 12, 2021 (JP) 2021-184841

(51) Int. Cl. G06V 20/52; G06V 10/60; G06V 10/74; G06V 40/10

(52) U.S. Cl. CPC G06V 20/52; G06V 10/60; G06V 10/761; G06V 40/10

(57) ABSTRACT

An information processing apparatus acquires a current image captured by an image capturing device in an entrance of a building, acquires associative information concerning an association with the current image, acquires a past image whose associative information agrees with or is similar to that of the current image, extracts a difference between the current image and the past image, and generates, on the basis of the extracted difference, a task request to request a task of assisting a user included in the current image, and outputs the generated task request.

### TECHNICAL FIELD

This relates to an information processing method, information processing apparatus, and information processing program.

### BACKGROUND ART

Patent Literature 1 discloses an entrance system that captures an image of a user staying in a platform of an entrance, determines a user ID from the captured image of the user, measures a body surface temperature of the user using a body temperature measurement device provided in the entrance, acquires weather information in consideration of a domicile of the user from a server of a weather forecast provider, and proposes the most suitable fashion item for the user on the basis of the user ID, the body surface temperature, and the weather information.

However, in the technology disclosed in Patent Literature 1, a difference between a current entrance image and a past entrance image is not extracted. Therefore, a further improvement is required to provide an assistance suitable to a user.

Patent Literature 1: Japanese Unexamined Patent Publication No. 2006-301973

### SUMMARY OF THE INVENTION

An object of the present disclosure is to provide a technique of offering an assistance suitable to a user on the basis of a difference between a current image and a past image.

An information processing method according to an aspect of the present disclosure is an information processing method that is for an information processing apparatus, and includes, by a processor of the information processing apparatus, acquiring a current image captured by an image capturing device in an entrance of a building; acquiring associative information concerning an association with the current image; acquiring a past image whose associative information agrees with or is similar to that of the current image; extracting a difference between the current image and the past image, and generating, on the basis of the extracted difference, a task request to request a task of assisting a user included in the current image; and outputting the generated task request.

This disclosure makes it possible to implement an assistance suitable to a user on the basis of a difference between a current image and a past image.

### BRIEF DESCRIPTION OF THE DRAWINGS

FIG. 1 is a diagram showing a general configuration of an information processing system according to an embodiment 1 of the present disclosure.

FIG. 2 is a block diagram showing a configuration of an exemplary information processing apparatus shown in FIG. 1.

FIG. 3 shows a data structure of an exemplary image information table.

FIG. 4 is an illustration showing an exemplary image captured by a camera.

FIG. 5 is a flowchart showing an exemplary process of an information processing apparatus according to the embodiment 1 of the present disclosure.

FIG. 6 is a block diagram showing a configuration of an exemplary information processing apparatus according to an embodiment 2.

FIG. 7 shows a data structure of an exemplary assistant table.

FIG. 8 is a flowchart showing an exemplary process of the information processing apparatus according to the embodiment 2 of the present disclosure.

FIG. 9 is a diagram showing a configuration of an exemplary information processing apparatus according to an embodiment 3 of the present disclosure.

FIG. 10 shows a data structure of an exemplary completion time table.

FIG. 11 shows a data structure of an exemplary necessary time period table.

FIG. 12 shows illustrations explaining an embodiment 4.

FIG. 13 is a diagram showing a configuration of an exemplary information processing apparatus according to an embodiment 5 of the present disclosure.

FIG. 14 shows a data structure of an exemplary task decision table.

### DETAILED DESCRIPTION

### Circumstances that Led to the Present Disclosure

Studies have been conducted about a monitoring system which monitors a child by notifying, when detecting an exit of the child on an image captured by a camera provided in an entrance of a dwelling, the image captured by the camera to a mobile terminal of a parent of the child.

The parent can see the notified image to know whether the child has left behind some due thing or not. For example, if the notified image shows that the child has no umbrella though a today weather forecast indicates rainfall at a time when the child leaves school, the parent can acknowledge that the child has left the umbrella behind, and carry the umbrella to the child.

However, there is an occasion that the parent can hardly perform an action of carrying the left thing to the child due to a job or like despite the acknowledgement on the notified image that the child has left the thing behind. In this case, there is a possibility that the child would come home wet in the rain without the umbrella. The parent who finds the child having got wet due to the rain is liable to feel mortified for not having been able to carry the umbrella thereto, and feel guilty to the child. In order to avoid such situation, it has been demanded to accomplish a service of automatically detecting the left thing of the child and carrying the left thing to the child.

For example, the Patent Literature 1 discloses a way of measuring a body surface temperature of a user in the platform of the entrance with the body temperature measurement device, and increasing an outdoor temperature threshold for proposing to wear a coat when the body surface temperature is beyond a threshold. In the Patent Literature 1, the image of the user staying in the entrance is captured by the camera, but the captured image is used only to determine the user ID, and no comparison is made between the current image and a past image whose associative information agrees with or is similar to that of the current image. Hence, a further improvement is required to provide an assistance suitable to the user who appears in the image, e.g., that of carrying the left thing to the user.

In view thereof, the present inventors found that such service can be accomplished by comparing a current image captured at an entrance with a past image whose associative information, e.g., a weather forecast, agrees with or is similar to that of the current image to automatically detect a due thing to be accompanied by a child today as the thing left behind, and generating a task for a third person to carry the left thing to the child.

The present inventors further found that the comparison between the current image with the past image whose associative information agrees with or is similar to that of the current image makes it possible to implement a service of offering various assistance to the user who appears in the image as well as the service that carries the left thing to a person who appears in the image. For example, the comparison between the current image and the past image in the same hour enables a deduction of a change in a sunset time on the basis of a change in outdoor brightness to implement a service of notifying the child of a message prompting an early return home.

The present disclosure has been worked out on the basis of the above findings.

An information processing method according to an aspect of the present disclosure is an information processing method for an information processing apparatus, and includes, by a processor of the information processing apparatus, acquiring a current image captured by an image capturing device in an entrance of a building; acquiring associative information concerning an association with the current image; acquiring a past image whose associative information agrees with or is similar to that of the current image; extracting a difference between the current image and the past image, and generating, on the basis of the extracted difference, a task request to request a task of assisting a user included in the current image; and outputting the generated task request.

In this configuration, a past image whose associative information agrees with or is similar to that of the current image is acquired, and a difference between the acquired past image and the current image is extracted. A past image that was captured under a circumstance having the same associative information is determined to be right and a difference between the past image and the current image is thereby extracted. This makes it possible to accurately identify information concerning the assistance required by the user included in the current image on the basis of the difference, thereby enabling implementation of an assistance suitable to the user.

In the information processing method, it may be appreciated that the difference concerns a due thing to be accompanied by the user, and the task is a task of carrying to the user the due thing to be accompanied by the user.

This configuration makes it possible to implement the assistance of carrying to the user the thing left behind.

In the information processing method, it may be appreciated that the difference concerns a change in outdoor brightness, and the task is a task of notifying the user of the message about return home.

This configuration enables notification to the user of the message about the return home on the basis of a change in outdoor brightness. This enables, for example, the implementation of a notification prompting the user to return home early because it is getting dark.

In the above information processing method, it may be appreciated that the difference concerns a combination of users when returning home, and the task is a task of ordering a foodstuff or controlling an appliance.

In this configuration, the task of ordering a foodstuff or the task of controlling an appliance is performed according to a difference in the combination of users when returning home. For example, a task that would have been performed by another user who usually comes home together with the user after their arrival at home can be automatically performed. This enables the implementation of an assistance for the user who has come home.

In the above information processing method, the associative information may include weather information.

In this configuration, a difference between the current image and the past image whose weather information agrees with or is similar to that of the current image is extracted. This makes it possible to detect a due thing to be accompanied by the user according to the current weather information.

In the above information processing method, in the generation of the task request, the task request may be generated using a task decision rule that associates in advance a difference item with a task item.

In this configuration, the task is determined using the task decision rule that associates in advance the difference item with the task item. Therefore, a task corresponding to the difference can be rapidly determined.

In the above information processing method, it may be appreciated that, in the output of the task request, an acceptance request that prompts an assistant who assists the first user to accept the task is output, and the task request is output when approval information indicating that the assistant has approved the acceptance request is obtained.

This configuration makes it possible to request a task while respecting the will of the candidate assistant.

In the above information processing method, it may be appreciated that, in the output of the task request, an execution time limit for the task is set on the basis of the difference item and user information indicative of the user, and the execution time limit is added to the acceptance request.

In this configuration, the execution time limit for the task is set on the basis of the difference item and the user included in a picture, and the set execution time limit is included in the acceptance request. This makes it possible to provide the assistant with information to determine whether to accept the acceptance request or not.

In the information processing method, the execution time limit may be set at a time that is a necessary time period for the task being predetermined according to the assistant and the user earlier than a completion time of the task being predetermined according to the user information and the difference item.

In this configuration, the execution time limit is set at the time that is the necessary time period for the task earlier than the completion time of the task. This makes it possible to complete the task by the completion time in consideration of the necessary time period for the task.

In the above information processing method, it may be appreciated that the difference item concerns a due thing to be accompanied by the user, the completion time is a time determined on the basis of a use start time of the due thing to be accompanied by the user, and the necessary time period is a time required to carry to the user the due thing to be accompanied by the user.

This configuration makes it possible to carry the due thing to be accompanied by the user to the user by the use start time of the due thing to be accompanied by the user.

In the above information processing method, the task may be performed by an assistant other than the user.

This configuration enables the assistant to assist the user.

In the above information processing method, it may be appreciated that the past image has further association with information indicating presence or absence of a task request, and in the extraction of a difference, a past image having no task request is specified on the basis of the information indicating presence or absence of a task request, and a difference between the specified past image and the current image is extracted.

In this configuration, the specified past image is a past image having no task request, which has a higher probability of including the information concerning the assistance required by the user. This makes it possible to determine the task suitable to the user.

In the above information processing method, in the extraction of a difference, in a case that a plurality of past images has the associative information agreeing with or being similar to that of the current image, it may be determined whether each of the past images differs from the current image, and a difference may be determined to exist when the number of past images determined to differ is greater than that of past images determined not to differ.

This configuration makes it possible to determine whether or not to generate a task request in consideration of the needs of the user.

An information processing apparatus according to another aspect of the present disclosure includes a first acquisition part that acquires a current image captured by an image capturing device in an entrance of a building; a second acquisition part that acquires associative information concerning an association with the current image; a third acquisition part that acquires a past image whose associative information agrees with or is similar to that of the current image; a generation part that extracts a difference between the current image and the past image, and generates, on the basis of the extracted difference, a task request to request a task of assisting a user included in the current image; and an output part that outputs the task request.

This configuration makes it possible to provide an information processing apparatus exhibiting the same advantageous effect as the above information processing method.

An information processing program according to a still another aspect of the present disclosure is an information processing program causing a computer to implement an information processing method for an information processing apparatus, the information processing program including: acquiring a current image captured by an image capturing device in an entrance of a building; acquiring associative information concerning an association with the current image; acquiring a past image whose associative information agrees with or is similar to that of the current image; extracting a difference between the current image and the past image and generating, on the basis of the extracted difference, a task request to request a task of assisting a user included in the current image; and outputting the generated task request.

This configuration makes it possible to provide an information processing program exhibiting the same advantageous effect as the above information processing method.

The present disclosure may be implemented also as an information processing system which operates in accordance with the information processing program. It is needless to say that the computer program may be distributed via a computer-readable non-transitory recording medium such as a CD-ROM or a communication network such as the Internet.

In addition, each of the embodiments described below shows a specific example of the present disclosure. The numerical values, shapes, constituent elements, steps, order of steps, and the like shown in the following embodiments are merely examples, and are not intended to delimit the present disclosure. Also, among the constituent elements in the following embodiments, constituent elements not recited in the independent claims representing the broadest concepts are described as optional constituent elements. In all the embodiments, the respective contents may also be combined.

### Embodiment 1

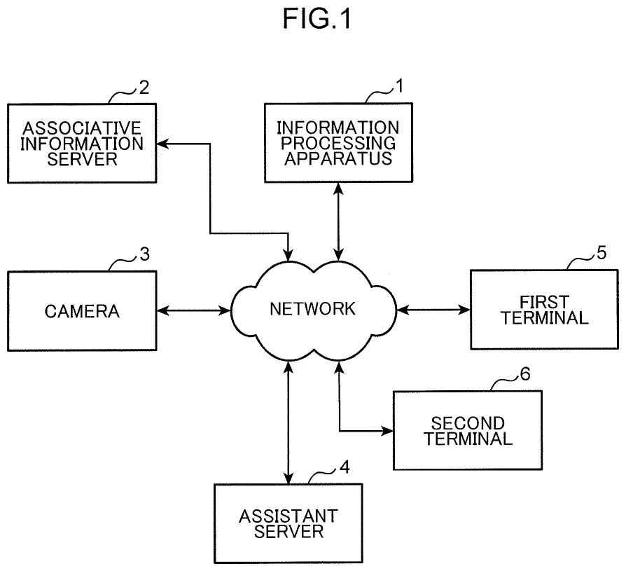

FIG. 1 is a diagram showing a general configuration of an information processing system according to an embodiment 1 of the present disclosure. The information processing system includes an information processing apparatus 1, an associative information server 2, a camera (image capturing device) 3, an assistant server 4, a first terminal 5, and a second terminal 6. The information processing system assists a user included in an image captured by the camera 3.

The information processing apparatus 1, the associative information server 2, and the assistant server 4 are cloud servers deployed on a network, for example. The information processing apparatus 1, the associative information server 2, the camera 3, the assistant server 4, the first terminal 5, and the second terminal 6 are mutually communicably connected via the network.

The camera 3 is a fixed camera arranged on a gateway of a building where a user to be assisted dwells. Hereinafter, the description will be made about a case that the gateway is an entrance. The camera 3 is arranged at a position of the entrance where a sightline is directed from an indoor space toward an outdoor space. Consequently, the image captured by the camera 3 is an image of an entrance space captured from the inside of the building. Therefore, when a user who is going out opens the door of the entrance, the camera 3 can capture an image of the entrance including an outdoor view. The image captured by the camera 3 can thus include outdoor environmental information. Further, since the image captured by the camera 3 is located at the entrance, the image can include a due thing accompanied by the user who is going out.

The position where the camera 3 is arranged is not limited to the entrance, but may be any position (e.g., in a room or on a corridor) as long as an image of the entrance can be captured from the position.

Alternatively, the camera 3 may be arranged at a gateway of the building different from the entrance as long as a user who is going out is detectable from the gateway. For example, the camera 3 may be arranged at a position on a boundary of a plurality of spaces in the building through which the user passes. In this case, the camera 3 can capture an image of a user who is moving across rooms, or a user who is moving through a door on a boundary between a living room and the entrance space. The camera 3 may be arranged at a gate, or on a corridor or in a room connected to the entrance.

The first terminal 5 may be, for example, a portable information terminal, e.g., a smartphone and a tablet type computer, or a stationary computer. For example, the first terminal 5 is carried by a person having a connection with the user included in the image captured by the camera 3. Hereinafter, the user included in the image is referred to as a first user, and a person having a connection with the first user is referred to as a second user. The first user is, for example, a child, and the second user is, for example, a custodian (mother or father) of the child.

The second terminal 6 may be, for example, a portable information terminal, e.g., a smartphone and a tablet type computer, or a stationary computer. The second terminal 6 is a terminal carried by an assistant for the first user.

The associative information server 2 includes a cloud server that provides weather information, and sends weather information to the information processing apparatus 1 in response to an acquisition request from the information processing apparatus 1. The camera 3 sends a captured image to the information processing apparatus 1. The information processing apparatus 1 generates a task request, and sends the generated task request to the assistant server 4. The weather information is, for example, information indicative of a weather forecast on that day. The weather information is, for example, information indicating that it will be sunny in the morning and it will be rainy from the afternoon onwards.

The assistant server 4 sends the task request sent from the information processing apparatus 1 to the second terminal 6 to thereby notify an assistant of the task request.

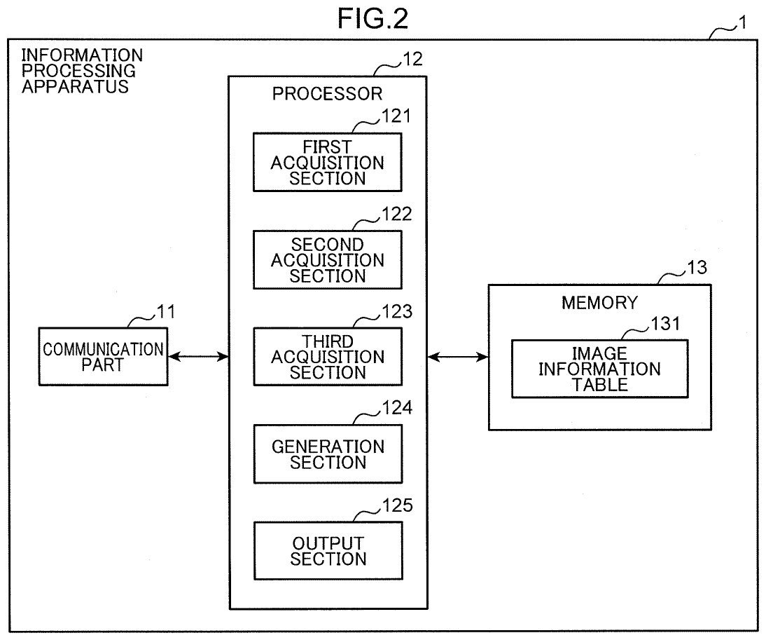

FIG. 2 is a block diagram showing a configuration of the exemplary information processing apparatus 1 shown in FIG. 1. The information processing apparatus 1 includes a communication part 11, a processor 12, and a memory 13. The communication part 11 is a communication circuit that connects the information processing apparatus 1 to the network. For example, the communication part 11 receives an image sent from the camera 3, and receives associative information sent from the associative information server 2. For example, the communication part 11 sends a task request to the assistant server 4.

The processor 12 is a processor including a CPU and the like, and includes a first acquisition section 121, a second acquisition section 122, a third acquisition section 123, a generation section 124, and an output section 125. The first acquisition section 121 to the output section 125 may be accomplished by an execution of an information processing program by the processor, or may be accomplished by a dedicated hardware circuit.

The first acquisition section 121 acquires the image captured by the camera 3 using the communication part 11. When the camera 3 is configured to capture an image of the entrance at a certain frame rate, the first acquisition section 121 acquires the image captured by the camera 3 at the certain frame rate. Further, the first acquisition section 121 may acquire an image of a person entering or exiting the entrance. In this case, the camera 3 may capture an image of the entrance at a time when an open and close sensor arranged at the door of the entrance detects the door being opened or closed, or at a time when a human sensing sensor arranged in the entrance detects a person.

The second acquisition section 122 acquires associative information associated with the current image captured by the camera 3, and records the acquired associative information in association with the image in an image information table 131 of the memory 13. The associative information includes, for example, weather information, and time and date information indicative of the current time and date. For example, when an image is acquired by the first acquisition section 121, the second acquisition section 122 sends an acquisition request of weather information to the associative information server 2, and acquires the weather information sent from the associative information server 2 in response to the acquisition request as the associative information. The time and date information includes, for example, year, month, date, and clock time.

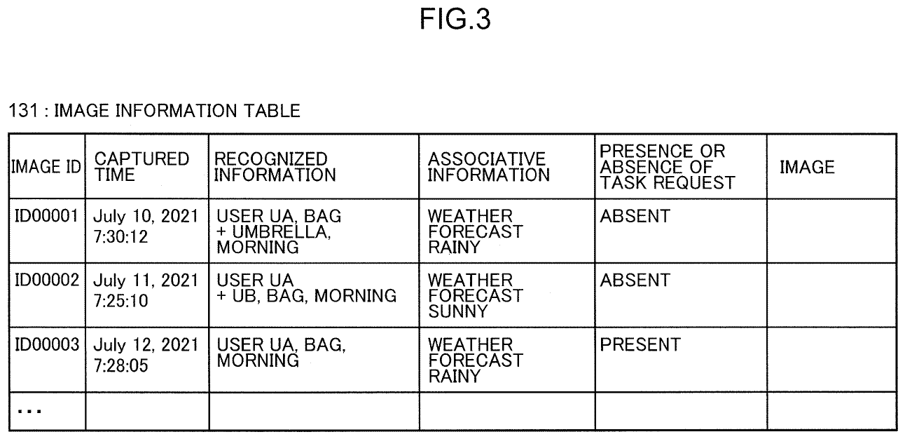

The third acquisition section 123 acquires a past image whose associative information agrees with or is similar to the current image acquired by the first acquisition section 121 among a plurality of past images recorded in the image information table 131 (FIG. 3) of the memory 13. For example, the third acquisition section 123 may acquire a past image associated with associative information including an item that agrees with or is similar to weather information acquired by the second acquisition section 122 from the image information table 131.

For example, when the weather information acquired by the second acquisition section 122 includes an item indicating a sunny morning and a rainy afternoon, the third acquisition section 123 acquires a past image associated with associative information including weather information indicating a sunny morning and a rainy afternoon from the image information table 131. For example, the third acquisition section 123 may judge similar to each other pieces of weather information having the same weather trend from the morning to the afternoon; e.g., weather information associated with one of the current image and the past image indicates a sunny morning and a rainy afternoon, and weather information associated with the other indicates a cloudy morning and a rainy afternoon. The weather trend includes a weather worsening trend over time and a weather improving trend over time.

The generation section 124 extracts a difference between the current image and a past image, and generates a task request to request a task of assisting the first user included in the current image on the basis of the extracted difference. For example, the generation section 124 generates a task request asking an assistant to carry to the first user a left thing when the difference satisfies a predetermined condition. The task refers to an action of an assistant or an execution of a computer to assist the first user. An exemplary assistance by the execution of the computer is a process of notifying the first user of a message of assisting the first user. An exemplary predetermined condition is a condition that there is the thing that was accompanied by the first user in a past image but is not accompanied by the first user in the current image. In other words, the exemplary predetermined condition is a condition that the first user does not carry the due thing that must be accompanied by the first user.

For example, the generation section 124 executes an image processing to thereby extract a person and a thing included in an image from both the current image and the past image. In the extraction, the generation section 124 determines which user among the users who dwell in the building corresponds to the extracted person. A processing using a recognizer for recognizing an object and a recognizer for recognizing a face of a person may be adopted as the image processing. For example, a facial recognition process may be adopted as the processing of identifying the person. The generation section 124 may compare a stored facial feature of each user who dwells in the building associated with a user ID with a facial feature of the person included in the image to thereby determine who is the person.

The generation section 124 compares the current image with a past image, and extracts an object that is included in the past image but is not included in the current image as a difference. When the object extracted as the difference is a due thing for the first user, the generation section 124 determines that the predetermined condition is satisfied. The due thing includes, for example, a bag, an umbrella, shoes, a jacket, a coat, a document, a sport uniform bag, a swimsuit bag, and a rainwear. For example, when the object extracted as the difference is located within a predetermined distance from the first user, the generation section 124 may determine that the object is a due thing to be accompanied by the first user.

The assistant is a person who performs a task to thereby assist the first user. The assistant may be, for example, an employee of an assistance service provider which carries to a user a left thing, or a local volunteer member.

The output section 125 sends the task request generated by the generation section 124 to the assistant server 4 by the communication part 11.

The memory 13 includes, for example, a non-volatile rewritable storage device, e.g., a hard disk drive and a solid-state drive. The memory 13 may be provided in an external server connected to the information processing apparatus 1 via the network. The memory 13 includes an image information table 131.

FIG. 3 shows a data structure of an exemplary image information table 131. The image information table 131 stores an image ID, a captured time, recognized information, associative information, presence or absence of a task request, and an image in association with one another. The image ID is an identifier of an image captured by the camera 3. The captured time is a time at which the camera 3 captures the image. The recognized information is information in an image recognized by the generation section 124 upon the image processing. The recognized information includes user information and information indicative of a due thing to be accompanied by the user. Further, the recognized information includes environmental information e.g., morning, afternoon, and evening. The generation section 124 may process an image to thereby specify the environmental information, or may specify the environmental information on the basis of the captured time of the image.

The associative information is associative information acquired by the second acquisition section 122 from the associative information server 2. At this time, weather information indicative of weather forecast of a day including the captured time of an image is recorded as the associative information.

The presence or absence of a task request refers to information indicating whether a task request is made about an image or not. For example, since a task of carrying an umbrella was performed in connection with the image ID00003, “Present” is marked in the field “Presence or absence of task request”.

The field “Image” stores an image captured by the camera 3.

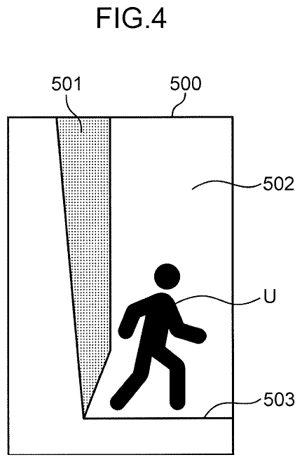

FIG. 4 is an illustration showing the exemplary image 500 captured by the camera 3. The image 500 is an image captured in a scene where the first user U opens the door 501 to go out. A sightline is directed from the indoor space toward the outdoor space, which allows the camera 3 to capture the image of the exit. A region 502 surrounded by a door frame 503 includes an outdoor picture to be described later.

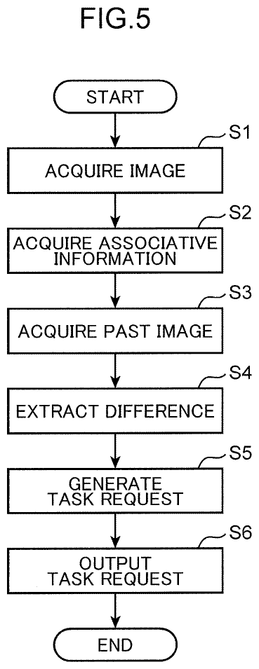

FIG. 5 is a flowchart showing an exemplary process of the information processing apparatus 1 according to the embodiment 1 of the present disclosure.

Step S1

The first acquisition section 121 acquires the image captured by the camera 3. The image captured at this time is a current image. In a case of adopting a configuration where an image is always sent from the camera 3, for example, the first acquisition section 121 may acquire an image having the captured time closest to the current time and containing the first user as the current image. Alternatively, the first acquisition section 121 may acquire an image having the latest captured time recorded in the image information table 131 and containing the first user as the current image. Further, the first user may be a specific user predetermined to receive the assistance.

Step S2

The second acquisition section 122 acquires associative information associated with the current image from the associative information server 2. At this time, weather information indicative of weather forecast at the current time is acquired as the associative information. The weather forecast is a today weather forecast. For example, the second acquisition section 122 may acquire weather information on the basis of information used to acquire the associative information. The information includes, for example, location information of the first user and time information indicative of the current time. The location information of the first user may be acquired from a portable terminal carried by the first user, or may be location information of the building. The location information of the building may be acquired from the memory 13. The time information may be acquired from an unillustrated clock included in the information processing apparatus 1, or may be acquired from an (unillustrated) external server connected to the network. The second acquisition section 122 may locate a region where the first user dwells on the basis of the location information of the first user or the location information of the building, and acquire the current weather information in connection with the region from the associative information server 2.

Step S3 The third acquisition section 123 acquires a past image whose associative information agrees with or is similar to that of the current image from the image information table 131. The determination as to whether pieces of associative information agree with or are similar to each other is made in a manner described above. If the associative information of the current image indicates the rain, since “ID00001” and “ID00003” have associated information indicating the rain in the example shown in FIG. 3, these images are acquired as the past images.

Step S4 The generation section 124 extracts a difference between the current image and the past image. At this time, as described above, an object that is included in the past image but is not included in the current image is extracted as the difference.

The generation section 124 may extract a difference between the current image and a past image about which “Absent” is marked in the field “Presence or absence of a task request” in the image information table 131. In this case, the specified past image has no task request, which has a higher probability of including a due thing to be accompanied by the first user. Therefore, the due thing to be accompanied by the first user can be extracted at a high accuracy by comparing this past image with the current image.

In a case that a plurality of past images has associative information agreeing with or being similar to that of the current image, the generation section 124 may calculate the number of images among the past images which have a difference from the current image satisfying a predetermined condition, and if the number of images is greater than the number of images having a difference not satisfying the predetermined condition, the generation section 124 may determine that the past images meet the predetermined condition. For example, even if a user does not carry an umbrella when it rains, it does not necessarily mean that a task request of carrying an umbrella arises, but it may depend on the needs of the user. In this case, there is no need to carry the umbrella to the first user. In this configuration, a task request of carrying a due thing is not generated in this case. Therefore, whether or not to generate a task request can be determined taking into account the needs of the first user.

Step S5 The generation section 124 generates a task request on the basis of the difference. As described above, at this time, if the object extracted as the difference is a due thing to be accompanied by the first user, a task request is generated to request an assistant for a task of carrying the due thing to the first user.

Step S6

The output section 125 sends (outputs) the task request to the assistant server 4 by the communication part 11. The assistant server 4 receives the task request, and sends the task request to an (unillustrated) portable terminal of the assistant. The task request includes a due thing to be carried, an address of a dwelling of the first user, and a destination of the carriage. The assistant goes to the dwelling of the first user, receives the due thing to be carried, moves to the destination of the carriage to deliver the due thing to the first user. The first user can thus obtain the left thing.

As described above, in the embodiment 1, a past image whose associative information agrees with or is similar to that of the current image is acquired, and a difference between the acquired past image and the current image is extracted. A past image that was captured under a circumstance having the same associative information is determined to be right and a difference between the past image and the current image is thereby extracted. This makes it possible to accurately identify information concerning the assistance required by the user included in the current image on the basis of the difference, thereby enabling implementation of an assistance suitable to the user.

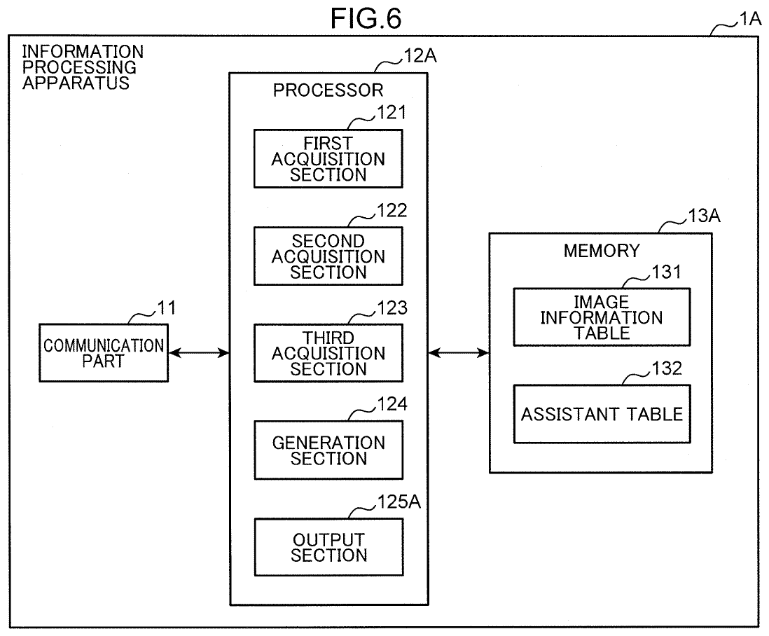

Embodiment 2 The embodiment 2 relates to inquiry as to whether a candidate assistant accepts a task request or not. FIG. 6 is a block diagram showing a configuration of an exemplary information processing apparatus 1A according to the embodiment 2. The information processing apparatus 1A differs from the information processing apparatus 1 at having an output section 125A of a processor 12A. The difference lies in that a memory 13A further stores an assistant table 132.

The output section 125A outputs via the communication part 11 to the assistant server 4 an acceptance request (first acceptance request) that prompts an assistant who assists a first user to accept the task, and outputs the task request via the communication part 11 to the assistant server 4 when approval information indicating that the candidate assistant has approved the first acceptance request is obtained via the communication part 11.

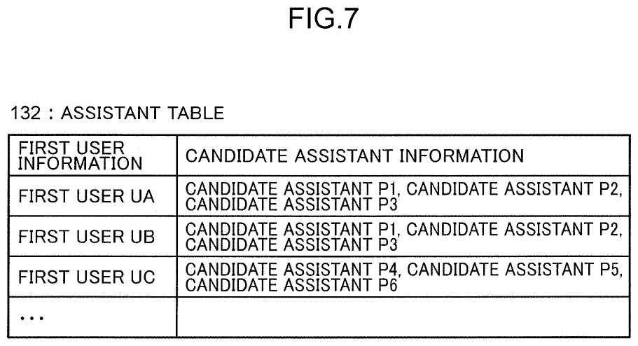

FIG. 7 shows a data structure of an exemplary assistant table. The assistant table 132 is a table that associates user information with candidate assistant information. The first user information is an identifier of a first user. The candidate assistant information is an identifier of a candidate assistant who is able to assist a first user. In an example shown in FIG. 7, candidate assistants P1, P2, P3 are specified in association with first users UA, UB, and candidate assistants P4, P5, P6 are specified in association with a first user UC. An assistant is definitively selected among these candidate assistants. The specification of candidate assistants in association with each first user makes it possible to definitely select an assistant among the candidate assistants who are able to skillfully assist a first user.

The assistant table 132 may preliminarily define a priority order among a plurality of candidates for each first user. Further, as shown in the cases of the first users UA, UB, the same candidate assistants may be associated with different first users. Additionally, the assistant table 132 may specify a candidate assistant according to a task item and a first user.

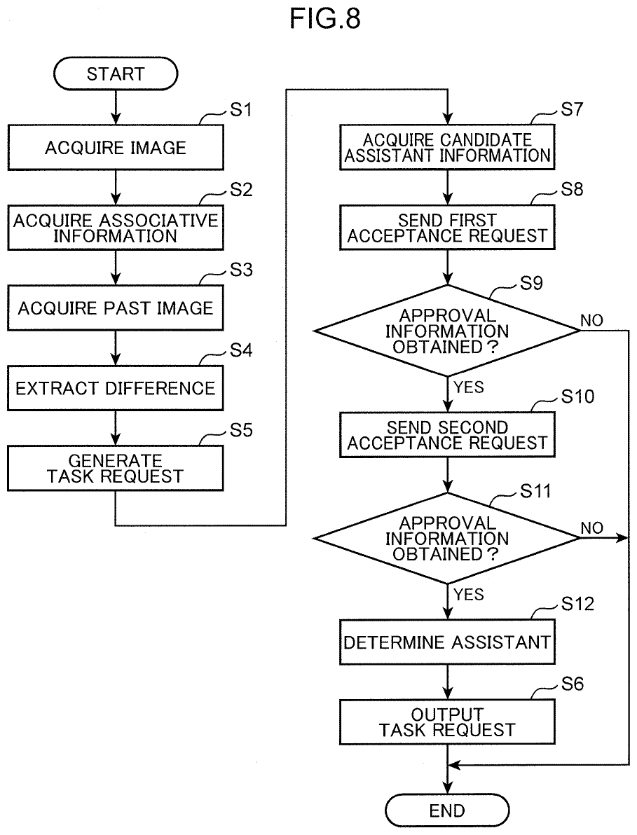

FIG. 8 is a flowchart showing an exemplary process of the information processing apparatus 1A according to the embodiment 2 of the present disclosure. Since the processings from Step S1 to Step S5 and Step S6 are the same as the processings in FIG. 5, the description thereof will be omitted.

Step S7

The output section 125A acquires candidate assistant information from the assistant table 132. For example, in a case that the first user UA is extracted from the current image, candidate assistant information concerning the candidate assistants P1, P2, and P3 are acquired.

In a case that the candidate assistants are recorded in the assistant table 132 in association with a task item and a first user, the output section 125A may acquire candidate assistant information associated with the task item and the first user.

Step S8 The output section 125A sends to the assistant server 4 a first acceptance request of inquiring as to whether a candidate assistant indicated by the acquired candidate assistant information accepts the task or not. After receiving the first acceptance request, the assistant server 4 may send the first acceptance request to a second terminal 6 carried by each candidate assistant to thereby notify the candidate assistant of the first acceptance request. The first acceptance request may include a task item and a requirement of the task request. The requirement of the task request is, for example, an execution time limit for the task. Further, the first acceptance request may include a history of a past time and date when the task was executed for the first user by an assistant.

Step S9

The output section 125A determines whether approval information is obtained from at least one candidate assistant. In a case that the approval information is obtained (YES in Step S9), the flow proceeds to Step S10. In a case that the approval information is not obtained (NO in Step

S9), the flow ends. For example, a candidate assistant who reads the first acceptance request inputs, when approving the first acceptance request, approval information to the second terminal 6, and inputs, when not approving the first acceptance request, disapproval information to the second terminal 6. The input approval information or disapproval information is input to the information processing apparatus 1A via the assistant server 4. When NO is determined in Step S9, the output section 125A sends to the first terminal 5 a message stating that none of the candidate assistants has accepted the requested task.

Step S10

The output section 125A sends via the communication part 11 to the first terminal 5 a second acceptance request of inquiring as to whether a second user approves the task. Accordingly, the second user who is a custodian of the first user is notified of the second acceptance request.

The second acceptance request includes the task item, a name of the candidate assistant who has input the approval information and the like. This provides the second user with information for determination about an approval or disapproval of the task. The first user may be notified of the second acceptance request of the task. In this case, the second acceptance request is sent to an (unillustrated) mobile terminal of the first user.

Step S11

The output section 125A determines whether approval information is obtained from the first terminal 5. In a case that the approval information is obtained (YES in Step S11), the flow proceeds to Step S12. In a case that the approval information is not obtained (NO in Step S11), the flow ends. For example, the second user who reads the second acceptance request inputs, when approving the second acceptance request, approval information to the first terminal 5, and inputs, when not approving the second acceptance request, disapproval information to the first terminal 5.

Step S12

The output section 125A selects the assistant among candidate assistants who has approved the first acceptance request. For example, if a plurality of candidate assistants has approved the first acceptance request, a candidate assistant among the candidate assistants is randomly selected as the assistant. Further, in a case that a priority order is preliminarily defined among the candidate assistants, the output section 125A selects as the assistant the candidate assistant having the highest priority among the candidate assistants who has approved the first acceptance request.

Step S6

The output section 125A sends a task request via the communication part 11 to the assistant server 4 to formally assign the task to the selected assistant. The task request is sent from the assistant server 4 to a second terminal 6 of the selected assistant. The selected assistant is thus notified of the task request.

In the case that the priority order is preliminarily defined among the candidate assistants, in Steps S9 to S12, the output section 125A sends the first acceptance request to one candidate assistant after another in a descending order of priority, and selects the assistant as soon as approval information is obtained.

As described above, in the second embodiment, the candidate assistants are notified of the first acceptance request, and the task request is done when approval information is input.

Therefore, the task request can be done that respects the will of the candidate assistants. Additionally, the second user is notified of the second acceptance request, and the task request is done when approval information is input. This can prevent the task from being performed without the acceptance of the second user.

Embodiment 3

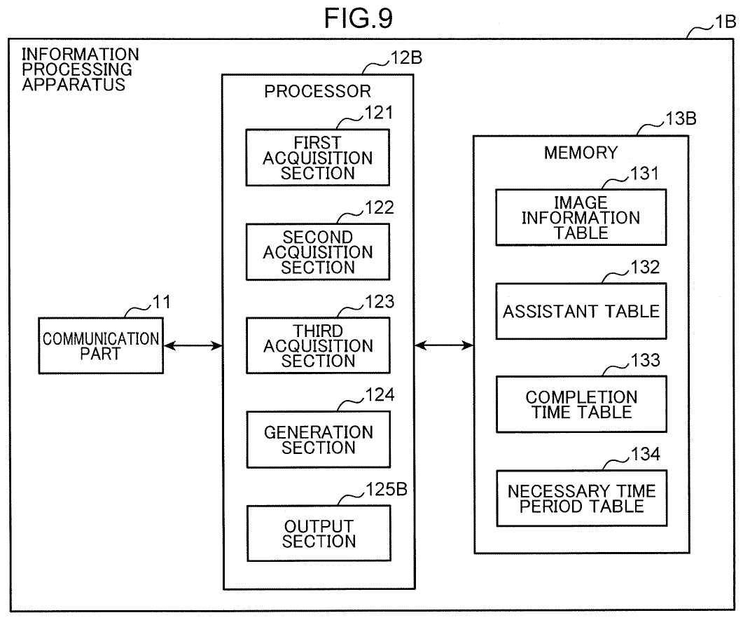

The embodiment 3 relates to setting of an execution time limit for the task. FIG. 9 is a diagram showing a configuration of an exemplary information processing apparatus 1B according to the embodiment 3 of the present disclosure. The information processing apparatus 1B differs from the information processing apparatus 1A in having an output section 125B of the processor 12A. The difference lies in that a memory 13B stores a completion time table 133 and a necessary time period table 134.

The output section 125B sets an execution time limit for the task on the basis of a difference item extracted by the generation section 124 and user information indicative of a first user. The execution time limit is, for example, a time limit by which an assistant should start the task. The execution time limit is set at a time that allows a task necessary time period predetermined according to an assistant and a first user before a task completion time predetermined according to user information of a first user and a difference item. The completion time is a time to be determined on the basis of a use start time of a due thing by a first user. The necessary time period is a time period required by an assistant to carry to a first user a due thing.

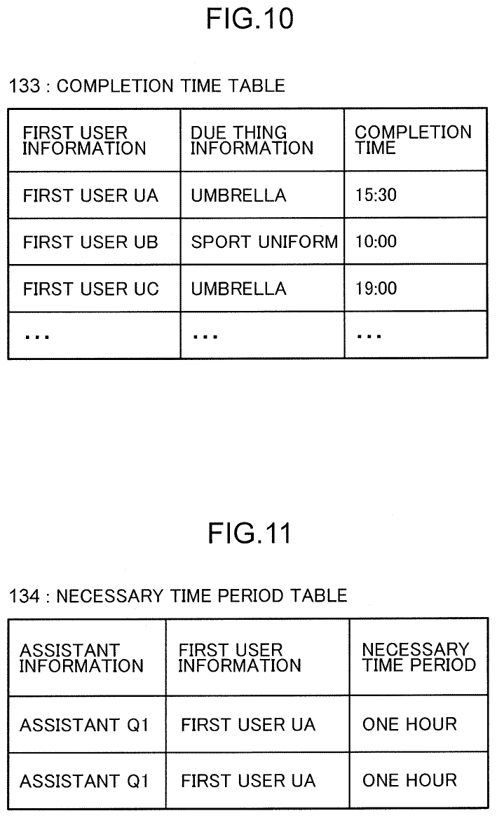

FIG. 10 shows a data structure of an exemplary completion time table 133. The completion time table 133 specifies a task completion time according to a first user and a due thing. The completion time table 133 stores first user information, due thing information, and a completion time in association with one another. The first user information is a user ID of a first user. The due thing information indicates an object determined to be a due thing to be accompanied by a first user. The completion time is a completion time of a task of an assistant of carrying a due thing to be accompanied by the first user. In an example of FIG. 10, the completion time for a task of carrying an umbrella in connection with a first user UA is set to 15:30. This takes into account a time when the first user UA comes home from a visited place (e.g., a school).

In connection with the first user UA, the completion time for the task of carrying him/her a sport uniform is set to 10:00. This takes into account a time when the first user UA will wear the sport uniform at a visited place. In connection with the user UB, the task of carrying the umbrella is set to 19:00. This takes into account a time when the first user UB comes home from a visited place (e.g., a cram school).

FIG. 11 shows a data structure of an exemplary necessary time period table 134. The necessary time period table 134 is a table that specifies a necessary time period according to an assistant and a first user. The necessary time period table 134 stores assistant information, first user information, and a necessary time period in association with one another. The assistant information is an identifier of an assistant. The identifier of an assistant coincides with an identifier of a candidate assistant. The first user information is an identifier of a first user. In an example of FIG. 11, the necessary time period is set to be one hour for an assistant Q1 and a first user UA.

This is because one hour is required by the assistant Q1 to carry a due thing to a place (school) visited by the first user UA. The necessary time period is set to be one hour for an assistant Q2 and the first user UA. This is because one hour is required by an assistant Q2 to carry a due thing to a place (school) visited by the first user UA.

The process of setting an execution time limit by the output section 125B is described below. Hereinafter, the description is made about a case where a first user who receives an assistance is the first user UA, the assistant is the assistant Q1, and a due thing to be carried is an umbrella. The output section 125B acquires the completion time “15:30” associated with the first user UA and the umbrella from the completion time table 133. Subsequently, the output section 125B acquires the necessary time period “one hour” associated with the assistant Q1 and the first user UA from the necessary time period table 134. Next, the output section 125B sets “14:30”, which results from the subtraction of the necessary time period “one hour” from the completion time “15:30”, as the execution time limit.

The output section 125B adds the set execution time limit to the first acceptance request described in connection with the embodiment 2 and sends the same to the assistant server 4. This first acceptance request is sent to the second terminal 6 of the assistant Q1. Therefore, the assistant

Q1 can see the execution time limit included in the first acceptance request to determine about approval or disapproval of the first assistance request.

As described above, in the embodiment 3, a necessary time period required by an assistant to carry a due thing to a place visited by a first user is subtracted from a completion time, that is a use time of the due thing by the first user, to thereby set an execution time limit, and the assistant is notified of a first assistance request including the execution time limit. This makes it possible to implement the assistance by an assistant who is available to carry the due thing by the use start time of the due thing by the first user.

Embodiment 4

The embodiment 4 relates to a task of sending a message about return home to a user.

Since the configuration of the information processing apparatus 1 according to this embodiment is the same as FIG. 2, the description is made with reference to FIG. 2. Alternatively, the information processing apparatus 1 according to the embodiment 4 may adopt the configurations shown in

FIG. 6 or FIG. 9. Hereinafter, a difference between the embodiment 4 and the embodiments 1 to 3 will be described. The description of the embodiment 4 about the same features as the embodiments 1 to 3 will be omitted.

With reference to FIG. 2, the first acquisition section 121 acquires an image captured by the camera 3 when a first user has come home as a current image. For example, the first acquisition section 121 may acquire an image which is taken in a predetermined return home time and includes a scene where a first user having opened a door enters the house from the outside as the image of the first user coming home.

The second acquisition section 122 acquires the captured time of the current image by the camera 3 and weather information as the associative information, and records the acquired captured time and weather information in association with the image in the image information table 131. The second acquisition section 122 may acquire the captured time included in the image sent from the camera 3 as the associative information.

The third acquisition section 123 acquires from the image information table 131 a past image which has a coincided or similar captured time and coincided or similar weather information to the current image. The past image having the coincided or similar captured time is a past image which had been captured a predetermined number of days before the current image and in the same time of day as the captured time of the current image. The predetermined number of days before are, for example, five to nine days before the captured time of the current image. The same time of day means, for example, a fixed time period including a time before and after the captured time of the current image. A desirable time period of five minutes, ten minutes, twenty minutes or the like can be adopted as the fixed time period. For example, assuming that the captured time of the current image is 17:00, a past image is an image that was captured in a time period between 16:50 to 17:10 seven days ago.

The third acquisition section 123 may acquire, as the past image, an image which includes a scene where the door is open and whose captured time and weather information coincides or are similar to the current image.

The generation section 124 extracts, as a difference, a negative change between an outdoor brightness obtained from the past image and an outdoor brightness obtained from the current image. In this case, the generation section 124 calculates the outdoor brightness on the basis of the luminance of the images. Further, the generation section 124 extracts a picture within a door frame appearing in the image as the outdoor picture showing the outside of the building, and calculate the outdoor brightness on the basis of the luminance of the outdoor picture. In this case, the outdoor brightness is denoted by a continuous value, or denoted by a grade of brightness in an evaluation of the brightness (e.g., a five-grade evaluation). The negative change indicates a value obtained by subtracting the brightness of the past image from the brightness of the current image.

Next, in a case that the extracted negative change in the brightness is greater than a predetermined value, the generation section 124 generates a task request to execute a task of notifying a first user of a message about return home. The predetermined value is, for example, a value leading to a presumption that if starting return home at the upcoming return home time, it will be difficult to return home during the time when the outside is under the daylight due to the imminent sunset.

The output section 125 sends the task request to the assistant server 4. After receiving the task request, the assistant server 4 generates notification information including a message prompting the user to go home earlier, and sends the generated notification information to the first terminal 5 or an (unillustrated) portable terminal carried by the first user. Accordingly, a custodian of the first user or the first user is notified of the message prompting an earlier return home.

The output section 125 may send, for example, the task request for this return home, or for a next return home. Since the embodiment 4 does not require the selection of an entrustee, the processings S7 to S12 in the flowchart in FIG. 8 are not necessary.

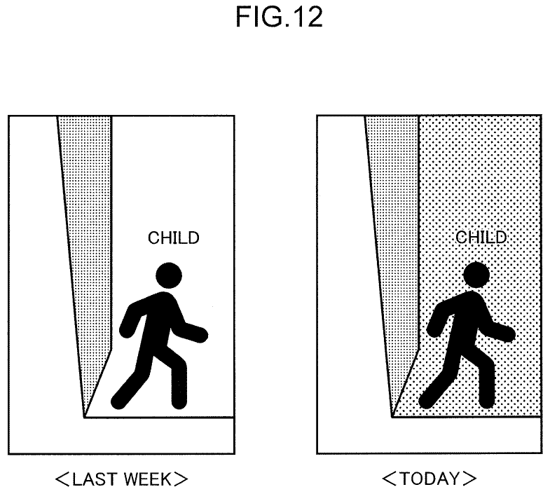

FIG. 12 shows illustrations explaining the embodiment 4. The illustration on the left shows an image of the first user coming home last week, while the illustration on the right shows an image of the first user coming home today. In the image showing the return home today, it is darker outside compared with the image showing the return home in the last week. This is because the daylight length is getting shorter due to a change of the season.

In this case, it is preferable that the first user goes home earlier in terms of security.

Accordingly, in the embodiment 4, when such a situation is detected, the first user is notified of a message prompting an earlier return home. In this way, the first user can be prompted to go home earlier the next time or later. This can ensure the security of the first user as well as give the custodian the sense of relief.

Embodiment 5 The embodiment 5 relates to determination of a task by referring to a task decision table.

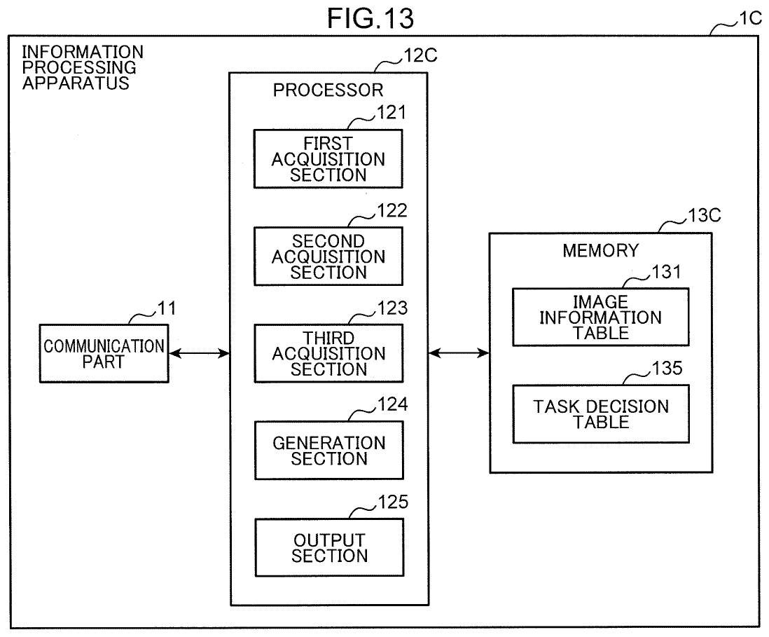

FIG. 13 is a diagram showing a configuration of an exemplary information processing apparatus 1C according to an embodiment 5 of the present disclosure. The information processing apparatus 1C differs from the information processing apparatus 1 in that a memory 13C further stores a task decision table 135.

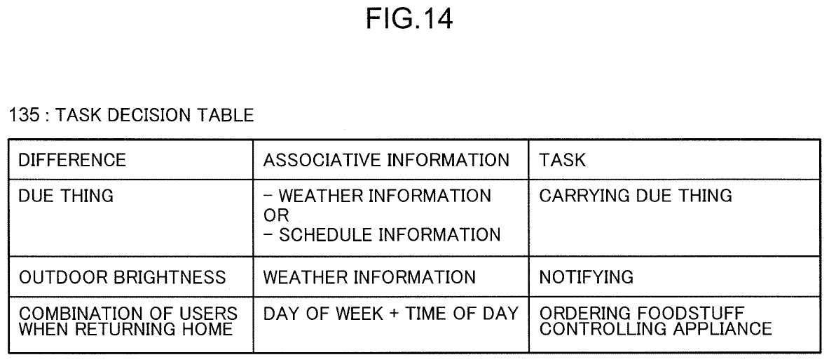

FIG. 14 shows a data structure of an exemplary task decision table 135. The task decision table 135 is a table to be referred to when the generation section 124 decides a task. The task decision table 135 specifies a task according to a difference item and associative information.

When the difference between the current image and the past image lies in a due thing to be accompanied by a first user, a task of carrying the due thing is performed. For example, in a case that the difference lies in the due thing, weather information is adopted as the associative information, and the task is determined in the same manner as in the embodiment 1.

Alternatively, when the difference lies in the due thing, schedule information of the first user may be adopted as the associative information. In this case, the second acquisition section 122 acquires the schedule information of the first user as the associative information. For example, the second acquisition section 122 acquires schedule information of the first user from an (unillustrated) external server storing schedule information, and stores the same in association with the current image in the image information table 131.

The third acquisition section 123 acquires a past image with the same or similar schedule information among the past images stored in the image information table 131. The schedule information is determined to be the same or similar to each other when, for example, one schedule information and the other schedule information include the same plan. An exemplary plan is the same lesson of the first user. Examples of the lesson include a cram school and a swimming lesson.

When the due thing extracted as the difference between the past image and the current image corresponds to an object necessary for a plan, i.e., when the past image includes the object necessary for the lesson but the current image does not include the object necessary for the lesson, the generation section 124 decides a task of carrying to the first user the object, and generates a task request concerning the task. Accordingly, the object necessary for the lesson is carried by an assistant, and the first user can receive the object at a place visited by the first user.

Further, as shown in FIG. 14, when the difference between the current image and the past image lies in the outdoor brightness when the first user comes home, a task of notifying a message concerning the return form is executed. Details of the process are the same as the embodiment 4.

Additionally, as shown in FIG. 14, in a case that the difference between the current image and the past image is a combination of users when returning home, a task of ordering a foodstuff or controlling an appliance is decided. In this case, the first acquisition section 121 acquires an image of the user coming home as the current image. The way of selecting the image at coming home is described above.

The second acquisition section 122 acquires a day of the week and a time of day when the current image is captured as the associative information, and stores the acquired day of the week and the time of day in association with the current image in the image information table 131.

The third acquisition section 123 acquires a past image whose day of the week and time of day coincide or are similar to the current image among the past images stored in the image information table 131. The day of the week and the time of day are determined to coincide or be similar when, for example, the images are captured on the same day of the week, and the captured times belong to the same time of day. For example, when the current image is captured on

Wednesday, at 17:30, past images captured on a Wednesday in the time of day between 17:00 and 18:00 are acquired.

The generation section 124 extracts as the difference a dissimilarity in the combination of included users between the current image and the past image. The difference in the combination of users indicates, for example, a case where the current image includes only a child whereas the past image includes the child and the custodian.

The generation section 124 generates a task request for performing a task of ordering a foodstuff or controlling an appliance when the difference in the combination satisfies a predetermined condition. An exemplary predetermined condition is a condition that the current image includes only the child whereas the past image includes the child and the custodian. An exemplary order of a foodstuff is an order of a home delivery or a foodstuff. An exemplary control of an appliance is a control of activating a washing machine and a control of a water supply system to fill a bath tub. A task request of the task of ordering a foodstuff may be an order request of ordering a preset cooked food or foodstuff from a predetermined supplier. A task request for the task of performing a control of an appliance may be a control signal for operating the appliance under a predetermined condition.

Accordingly, in a case that a child who usually comes home together with his/her custodian does not come home with his/her custodian today, the order of the foodstuff or the control of the appliance are automatically executed so that an assistance for the life of the child can be implemented.

The generation section 124 selectively implements one of the three tasks shown in FIG. 14 depending on the difference. For example, in a case that the difference item concerns a due thing, the task of carrying the due thing is selectively implemented. In a case that the difference item concerns outdoor brightness, the task of notifying the user of the message concerning return home is selectively implemented. In a case that the difference item concerns the combination of users returning home, the task of ordering the foodstuff and/or controlling the appliance is selectively implemented.

Modification 1

The generation section 124 may selectively implement the task to be referred to in the task decision table 135 depending on the time of day. For example, the generation section 124 may selectively implement only the task concerning the due thing in the morning, and may selectively implement the task concerning the combination of users and/or outdoor brightness in the afternoon.

Modification 2 The second acquisition section 122 may not store the acquired associative information in association with an image in the memory 13. For example, a configuration may be adopted where a server different from the information processing apparatus 1 includes a database to store associative information and a past image in association with each other. In this case, the third acquisition section 123 may acquire from this database a past image whose associative information agrees with or is similar to the current image.

The present disclosure is useful in the technical field which offers an assistance suitable to a user. Claims

1. An information processing method for an information processing apparatus, comprising:
by a processor of the information processing apparatus, acquiring a current image captured by an image capturing device in an entrance of a building;
acquiring associative information concerning an association with the current image;
acquiring a past image whose associative information agrees with or is similar to that of the current image;
extracting a difference between the current image and the past image, and generating, on the basis of the extracted difference, a task request to request a task of assisting a user included in the current image; and
outputting the generated task request.

2. The information processing method according to claim 1, wherein the difference concerns a due thing to be accompanied by the user, and the task is a task of carrying to the user the due thing to be accompanied by the user.

3. The information processing method according to claim 1, wherein the difference concerns a change in outdoor brightness, and the task is a task of notifying the user of a message about return home.

4. The information processing method according to claim 1, wherein the difference concerns a combination of users when returning home, and the task is a task of ordering a foodstuff or controlling an appliance.

5. The information processing method according to claim 1, wherein the associative information includes weather information.

6. The information processing method according to claim 1, wherein in the generation of the task request, the task request is generated using a task decision rule that associates in advance a difference item with a task item.

7. The information processing method according to claim 1, wherein in the output of the task request, an acceptance request that prompts an assistant who assists a first user to accept the task is output, and the task request is output when approval information indicating that the assistant has approved the acceptance request is obtained.

8. The information processing method according to claim 7, wherein in the output of the task request, an execution time limit for the task is set on the basis of the difference item and user information indicative of the user, and the execution time limit is added to the acceptance request.

9. The information processing method according to claim 8, wherein the execution time limit is set at a time that is a necessary time period for the task being predetermined according to the assistant and the user earlier than a completion time of the task being predetermined according to the user information and the difference item.

10. The information processing method according to claim 9, wherein the difference item concerns a due thing to be accompanied by the user, the completion time is a time determined on the basis of a use start time of the due thing to be accompanied by the user, and the necessary time period is a time required to carry to the user the due thing to be accompanied by the user.

11. The information processing method according to claim 1, wherein the task is performed by an assistant other than the user.

12. The information processing method according to claim 1, wherein the past image further has an association with information indicating presence or absence of a task request, and in the extraction of a difference, a past image having no task request is specified on the basis of the information indicating presence or absence of a task request, and a difference between the specified past image and the current image is extracted.

13. The information processing method according to claim 1, wherein in the extraction of a difference, in a case that a plurality of past images has the associative information agreeing with or being similar to that of the current image, it is determined whether each of the past images differs from the current image, and a difference is determined to exist when the number of past images determined to differ is greater than that of past images determined not to differ.

14. An information processing apparatus, comprising:
a first acquisition part that acquires a current image captured by an image capturing device in an entrance of a building;
a second acquisition part that acquires associative information concerning an association with the current image;
a third acquisition part that acquires a past image whose associative information agrees with or is similar to that of the current image;
a generation part that extracts a difference between the current image and the past image, and generates, on the basis of the extracted difference, a task request to request a task of assisting a user included in the current image; and
an output part that outputs the task request.

15. Non-transitory computer readable recording medium storing an information processing program causing a computer to implement an information processing method for an information processing apparatus, the information processing program comprising:
acquiring a current image captured by an image capturing device in an entrance of a building;
acquiring associative information concerning an association with the current image;
acquiring a past image whose associative information agrees with or is similar to that of the current image;
extracting a difference between the current image and the past image and generating, on the basis of the extracted difference, a task request to request a task of assisting a user included in the current image; and
outputting the generated task request.
